(19) United States
(12) Patent Application Publication
(10) Pub. No.: US 2004/0054852 A1
(43) Pub. Date: Mar. 18, 2004

(54) Cache/prefetch frame of serial data system and operation method of the same

(76) Inventors: Yueh-Yao Nain, Hsinchu (TW); Yung-Ming Lin, Taichung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,918

(22) Filed: Nov. 29, 2002

(30) Foreign Application Priority Data
Sep. 17, 2002 (TW) 91121211

(51) Int. Cl. G06F 12/00

(52) U.S. Cl. 711/137; 711/167

(57) ABSTRACT

A cache/prefetch frame of serial data system and an operation method of the same. The cache/prefetch frame has a main controller, a main controller bus, a prefetch circuit, and a serial memory. The cache/prefetch frame of serial data system uses a serial interface between the main controller and the serial memory, such that the pins of the interface are decreased and consequently, the cost is reduced. The low-cost prefetch circuit is built in the main controller to overcome the drawback of the relatively low bandwidth between the main controller and the serial memory. The operation method of the cache/prefetch frame uses clock control to determine the timing for providing a clock signal to the main controller, such that bugs or shutdown caused by long waiting time of the main controller is prevented.

### CROSS REFERENCE TO RELATED APPLICATIONS

This application claims the priority benefit of Taiwan application serial no. 91121211, filed Sep. 17, 2002.

### BACKGROUND OF INVENTION

1. Field of the Invention

The invention relates in general to a cache/prefetch frame of a data system and an operation method of the same, and more particularly, to a cache/prefetch frame and an operation of a serial data system.

2. Related Art of the Invention

The application a serial data system has introduced the development of many relative frames and accesses. For example, in a conventional display such as a liquid crystal display (LCD) monitor, plasma television, liquid crystal display projector or a liquid crystal display television, two types of system frames as shown in FIGS. 1A and 1B have been developed with respect to the relationship between a main controller and a scaler.

FIG. 1A shows a conventional circuit structure of a main controller 14 and a scaler 10. The circuit structure comprises a scaler 10, a display module 12, a main controller 14, an analog front end 102, an indicator 104, and an optical scanner 106. The main controller 14 further includes a flash memory therein. In the circuit structure, the main controller 14 mounted to the external of the scaler 10 is linked therewith by a serial interface. Although the connection by the serial interface reduces the number of external pins, the insufficient bandwidth of the serial flash memory 142 degrades the performance. In addition, the integrated circuit of the flash memory 142 built in the main controller is not made by normal fabrication process of a flash memory. Instead, the fabrication process of an embedded flash memory is used, increasing the cost.

FIG. 1B shows another conventional circuit structure of a main controller 208 and a scaler 20. The circuit structure comprises the scaler 20, a display module 22, a parallel interfaced flash memory 24, an analog front end 202, an indicator 204, an optical scanner, and the main controller 208. The main controller 208 is installed in the scaler 20, while the scaler 20 carries the parallel interface flash memory 24 externally. A parallel connection between the main controller 208 and the flash memory 24 is adapted to meet with the bandwidth requirement of the main controller 208, such that the expensive process for the embedded flash memory is waived. However, too many pins of the parallel interface increase the cost of package of the scaler 20.

According to the above, the drawbacks of the connecting interface between the main controller and the memory include:

(1) The process for the embedded flash memory is required for building the flash memory in the main controller 14. As a result, the cost is raised.

(2) When the scaler 10 mounted external of the main controller 14 is connected thereto by a serial interface, the bandwidth of the flash memory 142 is insufficient causing performance degradation.

(3) When the scaler 20 comprises the main controller 208 therein and carries the flash memory 24 externally, too many pins occupying the parallel interface increase the package cost of the scaler 20.

### SUMMARY OF INVENTION

The present invention provides a cache/prefetch frame of a serial data system that uses a serial interface to reduce the interface pin count between the main controller and the memory. A prefetch circuit is built in the main controller to overcome the drawback of insufficient bandwidth of the memory.

The present invention further provides an operation method of a serial data system, that is, the access method of the serial memory includes sequentially outputting data after inputting the initial address. In addition, the time for outputting the data unit is shorter than the time interval for fetching the data unit from the data address by the main controller bus.

The cache/prefetch circuit of a serial data system provided by the present invention comprises a main controller, a prefetch circuit, a serial memory, a main controller bus and a serial bus. The main controller is a unit operating according to a clock signal and accessing the data in the serial memory via the main controller bus. The prefetch circuit is connected to the main controller for providing data and temporarily storing the program code to be executed by the main controller. The prefetch circuit also prefetches the command and data required by the main controller. The data of the serial memory is provided to the prefetch circuit via the serial bus.

The prefetch circuit further comprises a buffer memory, a control circuit and a transmission control line. The buffer memory stores the data from the serial memory. The control circuit controls the serial memory to provide the data to the buffer memory according to a command, and controls the buffer memory to provide the data stored therein to the main controller. The transmission control line temporarily stops the data transmission of the serial memory when the buffer memory is full, and continues the data transmission when the buffer memory has available space.

The cache/prefetch frame of the serial data system further comprises a clock control mechanism that temporarily stops providing the clock signal to the main controller when the data required by the main controller does not exist in the buffer memory and continues providing the clock signal when the data is stored in the buffer memory.

The operation method of a cache/prefetch frame provided by the present invention includes the following steps. After the data address is output from the main controller, a data corresponding to the data address is searched using the prefetch circuit. Meanwhile, whether the data corresponding to the data address is stored in the prefetch circuit is determined. If the data has been stored in the prefetch circuit, the data corresponding to the data address is transmitted to the main controller via the main controller bus. If the data corresponding to the data address is not stored in the prefetch circuit, the data address is transmitted to the serial memory, and the data corresponding to the data address is transmitted to the main controller via the main controller bus using the prefetch circuit.

### BRIEF DESCRIPTION OF DRAWINGS

These, as well as other features of the present invention, will become more apparent upon reference to the drawings wherein:

FIG. 1A shows a circuit block diagram of the conventional scaler and main controller connected via a serial interface;

FIG. 1B shows a circuit block diagram of the conventional scaler including a built-in main controller and an external flash memory;

FIG. 2 shows a circuit block diagram of a scaler with a built-in prefetch circuit and an external flash memory in one embodiment of the present invention;

FIG. 3 shows a block diagram of the cache/prefetch frame of a serial data system in one embodiment of the present invention; and

FIG. 4 shows the process flow of an operation method of a cache/prefetch frame of a serial data system.

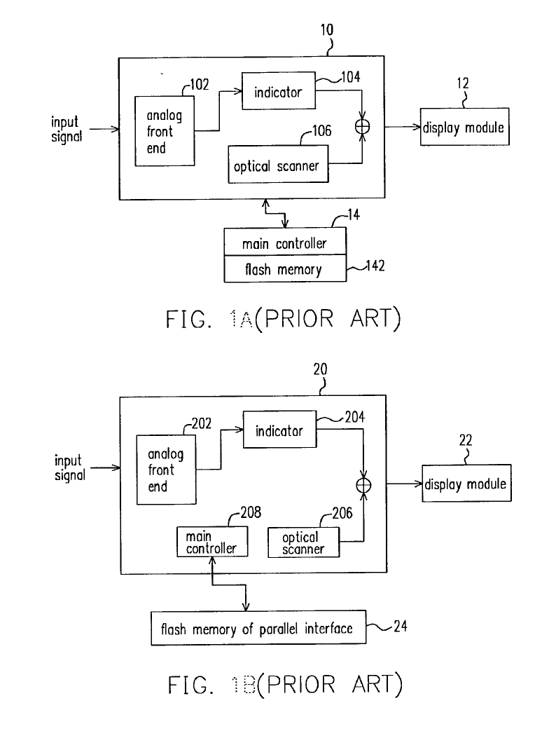

### DETAILED DESCRIPTION

First Embodiment

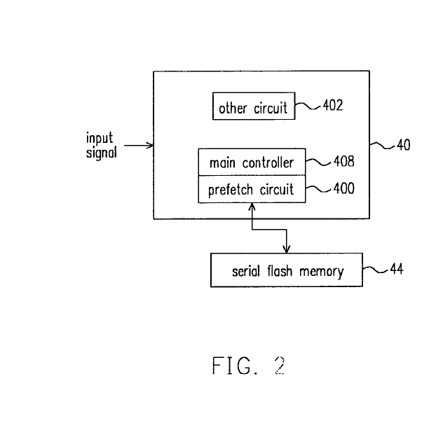

FIG. 2 shows a circuit block diagram of a cache/prefetch frame of a serial data system with a built-in prefetch circuit and an external flash memory. FIG. 2 includes a scaler 40 and the other circuit 402, in which a flash memory 44, a prefetch circuit 400 and a main controller 408 constructs the cache/prefetch frame of a serial data system. The scaler 40 includes the main controller 408 and the built-in prefetch circuit 400. In addition, the scaler 40 also includes the external flash memory.

According to the present invention, being built in the scaler 40, the prefetch circuit 400 prefetches the data and command required by the main controller 408 for the main controller 408 to use. The problem of insufficient bandwidth of the serial flash memory 44 is resolved, and the external pins of the scaler 40 are decreased to reduce the package cost of the scaler 40. Further, the serial flash memory 44 is made by the fabrication process of normal flash memory, so that the cost increment for building the prefetch circuit 400 in the scaler 40 is relative low.

Second Embodiment

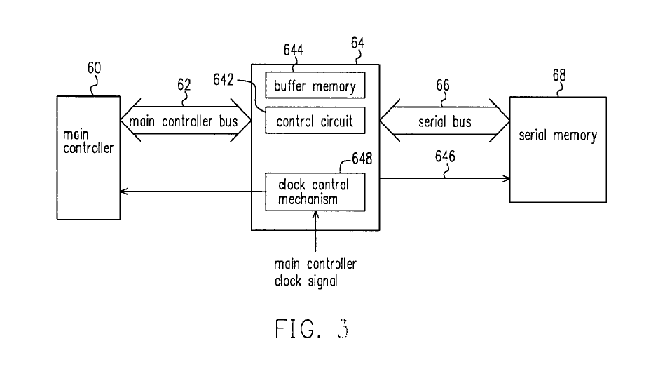

Referring to FIG. 3, a schematic block diagram of a cache/prefetch frame of a serial data system is illustrated. The main controller 60 operates according to a clock signal. Via the main controller bus 62, a command is output to obtain the data. As known to people skilled in the art, the main controller 60 includes an 8-bit or 1 6-bit main controller, however, it is not limited thereto. Further, the prefetch circuit 64 is connected to the maincontroller bus 62 to provide the data and prefetch the command and data required by the main controller 60 for the main controller 60 to use. The serial memory 68 provides the data to the prefetch circuit 64 via the serial bus 66. As known to those skilled in the art, the serial bus 66 interface includes an I2C bus, a serial peripheral interface bus or an LPC bus, but is not limited thereto.

The prefetch circuit 64 further comprises a buffer memory 644, a control circuit 642 and a transmission control line 646. The buffer memory 644 stores the data transmitted from the serial memory 68. The control circuit 642 controls the serial memory 68 to provide the data to the buffer memory 644 and control the buffer memory 644 to provide the data stored therein to the main controller 60. The transmission control line 646 temporarily stops the data transmission of the serial memory 68 when the buffer memory 644 is full, and continues the data transmission of the serial memory 68 when the buffer memory 644 has available storage space.

The cache/prefetch frame of the serial data system further includes a clock controller mechanism 648. When the data required by the main controller 60 does not exist in the buffer memory 644, the clock signal is prevented from being provided to the main controller 60 temporarily. When the data is stored in the buffer memory 644, the clock signal is provided to the controller 60.

Further referring to FIG. 3, the operations of the cache/prefetch frame of the serial data system are as follows. The main controller 60 outputs the data address via the main controller bus 62. The control circuit 642 of the prefetch circuit 64 determines whether the data corresponding to the data address is~stored in the buffer memory 644. When the data corresponding to the data address is stored in the buffer memory 644, the data is then transmitted to the main controller 60 via the main controller bus 62, and the clock control mechanism 648 continues providing the clock signal to the main controller 60. If the data is stored in the buffer memory 64, the clock control mechanism 648 temporarily stops providing the clock signal to the main controller 60. The data address output from the main controller 60 is transmitted to the serial memory 68 via the serial bus 66. The data corresponding to the data address and the subsequent data thereof are sequentially transmitted to the buffer memory 644 from the serial memory 68. The clock control mechanism 648 continues providing the clock signal to the main controller 60, and the data corresponding to the data address is transmitted to the main controller via the main controller bus 66. When buffer memory 644 is full, the data transmission control line 646 temporarily stops the data transmission of the serial memory 68. When the buffer memory 644 has available storage space, the data transmission of the serial memory 68 is resumed.

Third Embodiment

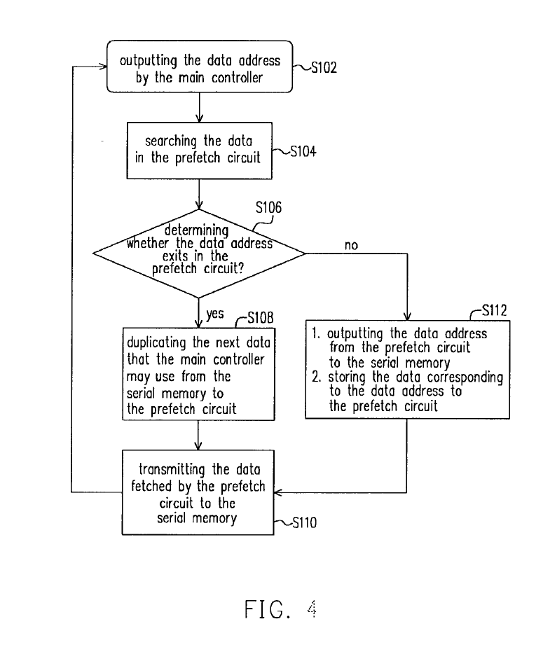

Referring to FIG. 4, the process flow of an operation method of a cache/prefetch frame of a serial data system is illustrated. The operation method is suitable for using the prefetch circuit to fetch data from the serial memory via the serial bus, and to transmit the data to the main controller from the main controller bus. The serial bus and the main controller bus use different communication protocols. The process is described as follows.

In step s102, the main controller outputs the data address to the prefetch circuit via the main controller bus. In step s104, the data corresponding to the data address is searched from the prefetch circuit. In step s106, the prefetch circuit is used to determine whether the data corresponding to the data address is stored in the prefetch circuit. In step s108, if the data is stored in the prefetch circuit, the next data that the main controller can use is duplicated from the serial memory to the prefetch circuit. In step s110, the data fetched in the prefetch circuit is stored in the main controller. In step s112, if the data corresponding to the data address is not existent in the prefetch circuit, the prefetch circuit outputs the data address to the serial memory and stores the data corresponding to the data address to the prefetch circuit.

In one embodiment of the present invention, the prefetch circuit further comprises a buffer memory to store the data transmitted from the serial memory and a transmission control line to temporarily stop data transmission of the serial memory when the buffer memory is full, and to resume the data transmission when the buffer memory has available memory space.

In one embodiment of the present invention, the clock control mechanism temporarily stops providing the clock signal to the main controller when the data corresponding to the data address required by the main controller does not exist in the buffer memory, and resumes providing the clock signal to the main controller when the data is stored in the buffer memory.

In a further embodiment of the present invention, when the reading method of the serial memory sequentially outputs the data after inputting the initial address and the time for outputting one unit data is shorter than the time for the main controller bus to output one unit data corresponding to the address received thereby, the buffer memory is not required in the prefetch circuit. That is, a real time fetch and response command can be achieved.

According to the above, the cache/prefecth frame of the serial data system provided by the present invention has the following advantages.

1. The clock control mechanism temporarily stops providing the clock signal to the main controller and resumes providing the clock signal after the data is stored in the buffer memory, such that bug or shutdown caused by the long waiting time of the main controller is avoided.

2. The prefetch circuit is external to the main controller instead of being built in the main controller.

3. The serial bus used in the present invention reduces the pin counts between the main controller and the serial memory, such that performance degradation caused by the serial bus is avoided.

4. The pins of the scaler are decreased by using the serial flash memory, such that the fabrication cost is reduced.

5. The external pins of the scaler are decreased by using the serial flash memory. Further, the serial flash memory can be made by the fabrication process of normal flash memory.

6. The prefetch circuit can be built in the scaler to overcome the problem of insufficient bandwidth for using the serial flash memory.

7. The cost for building the prefetch circuit built in the scaler is relatively low.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A cache/prefetch frame of a serial data system, comprising:
a main controller, operating according to a clock signal;
a main controller bus, wherein the main controller fetches a data by outputting a command via the main controller bus;
a prefetch circuit, connected to the main controller bus to provide the data; and
a serial memory, providing the data to the prefetch circuit via a serial bus.

2. The cache/prefetch frame according to claim 1, wherein the main controller includes a 16-bit controller.

3. The cache/prefetch frame according to claim 1, wherein the main controller includes an 8-bit controller.

4. The cache/prefetch frame according to claim 1, wherein the serial bus includes an I2C bus, a serial peripheral interface bus or an LPC bus.

5. The cache/prefetch frame according to claim 1, wherein the prefetch circuit further comprises:
a buffer memory, to store the data transmitted from the serial memory; and
a control circuit, operative to control the serial memory to provide the data to the buffer memory according to the command and to control the buffer memory to provide the data stored therein to the main controller.

6. The cache/prefetch frame according to claim 1, further comprising a clock control mechanism to temporarily stop providing the clock signal to the main controller when the data is not stored in the buffer memory, and to resume providing the clock signal to the main controller after the data is saved in the buffer memory.

7. The cache/prefetch frame according to claim 1, wherein the prefetch circuit further comprises a transmission control line to temporarily stop data transmission of the serial memory when the buffer memory is full, and to resume the data transmission of the serial memory when the buffer memory has available storage space.

8. An operation method of a cache/prefetch frame of a serial data system, suitable for a prefetch circuit fetching a data from a serial memory via a serial bus, and transmitting the data to a main controller via a main controller bus, wherein the serial bus and the main controller bus use different communication protocols, the operation method comprising:
a. outputting a data address from the main controller;
b. searching a data corresponding to the data address in the prefetch circuit;
c. determining whether the data is stored in the prefetch circuit or not;
d. transmitting the data to the main controller via the main controller bus when the data exists in the prefetch circuit, and going to step g;
e. outputting the data address to the serial memory;
f. duplicating the data to the prefetch circuit; and
g, resuming a data that the main controller may use from the serial memory to the prefetch circuit.

9. The operation method according to claim 8, wherein the prefetch circuit further comprises a buffer memory to store the data transmitted from the serial memory.

10. The operation method according to claim 8, wherein when the data corresponding to the data address does not exist in the prefetch circuit, a clock signal is temporarily stopped from being provided to the main controller, and the clock signal is resumed to the main controller after the data is stored in the buffer memory.

11. The operation method according to claim 8, wherein the prefetch circuit further comprises a transmission control line to temporarily stop data transmission of the serial memory when the buffer memory is full, and to resume the data transmission of the serial memory when the buffer memory has available storage space.

12. The operation method according to claim 8, further comprising a reading method of the serial memory that sequentially outputs the data after an initial address is input.

13. The operation method according to claim 8, wherein the serial memory outputs a unit data within a time shorter than that for the main controller bus outputting an address or receiving a unit data corresponding to the address.
